(19) United States
(12) Patent Application Publication
(10) Pub. No.: US 2025/0193666 A1
(43) Pub. Date: Jun. 12, 2025

(54) SYSTEM AND METHOD FOR CONVENIENT AND SECURE AUTHENTICATION IN A MOBILE DEVICE ENVIRONMENT

(71) Applicant: Jason Dean Hart, Fremont, CA (US)

(72) Inventor: Jason Dean Hart, Fremont, CA (US)

(21) Appl. No.: 18/977,713

(22) Filed: Dec. 11, 2024

Related U.S. Application Data
(60) Provisional application No. 63/608,605, filed on Dec. 11, 2023.

(51) Int. Cl. H04W 12/06; G01S 17/08; G01S 17/50; G01S 17/88; H01Q 1/22; H04W 12/63

(52) U.S. Cl. CPC H04W 12/06; G01S 17/08; G01S 17/50; G01S 17/88; H01Q 1/2291; H04W 12/63

(57) ABSTRACT

The present invention is a sensor device comprising an omnidirectional BLE radio antenna, a unidirectional BLE radio antenna, a forward-facing LiDAR, and output logic to instruct access or to control local access to a resource, e.g. a door lock. The preferred embodiment of the present invention further comprises an optical camera and a radar. In the preferred embodiment of the present invention, said sensor device can utilize commonly found legacy wiring for power combined with WiFi signaling for high speed data transfer.

The present invention teaches a method of combining different sensors and radio antennas to address the unpredictable state of transmission characteristics of a mobile handset's BLE radio to accurately determine a person's intention to authenticate to a door or computer merely by their physical action of approaching a door or computer.

### FIELD OF THE INVENTION

The present invention relates generally to sensor detection and identification. Particularly, the present invention is a system and method for employing multiple forms of sensor detection and communications to enable a person to use a mobile handset as a form of accurate identification at different distances across a plurality of mobile device types in a variety of physical orientations.

### BACKGROUND OF THE INVENTION

The use of multi-function mobile handset devices has become increasingly popular as a method of replacing physical keys and RFID plastic cards. Mobile handsets often contain one or more forms of external communication suitable for localized authentication to an external reader, such as a door reader, desktop computer reader, etc.

One ubiquitous method across global handset devices is Bluetooth Low Energy communication (BLE). BLE operates on the ISM 2.4 GHz globally-available radio band and is intended for close range communication. As incorporated into handset devices, this radio technology is omnidirectional, meaning that it communicates in all directions equally. However, this is not the case in practice, as mobile handset vendors design the small 2.4 GHz antenna inside compact housing alongside metal components. Users adding accessories such as protective cases and metallic stickers to the mobile handset further interferes with or distorts the signal of BLE communication.

Identifying a person using a digital credential on their mobile handset involves a software program known as a wallet. The wallet contains one or more digital credentials. The wallet uses the mobile handset's radios to communicate with external reader devices over different technology such as NFC, UWB, Visual QR codes, Infrared, WiFi and BLE. When a digital wallet is using BLE to communicate with a reader, the reader or the handset relies upon the signal strength of the arriving packets to determine the approximate distance that the mobile handset is away from the reader.

Most mobile device wallets have two modes of operation. The first mode comprises a manual mode whereby the mobile handset user must perform some action on the handset to indicate their intent to use the credential from the wallet. These actions include pushing a button on the screen, shaking the mobile handset, tapping the handset, presentation of a biometric such as facial recognition, etc. Once the manual indication of intent is detected by the wallet, the wallet generally transmits the virtual credential in some secure manner to the reader. The second mode comprises an automated mode whereby the user's intent to transmit the credential is determined by the reader or mobile handset without any direct interaction with the handset by the user. For example, the most common form is walking to a door. The wallet and reader determine the user's intent by the closing of the distance between the mobile handset and the reader. This approach is the most popular and typically uses the signal strength of the communication between the handset and the reader to determine distance.

This approach of using the radio signal strength between the mobile handset 2.4 GHz radio and the radio of the reader is flawed in practice for many reasons, including: the orientation of the handset antenna changes in relation to the orientation of the reader antenna as the user moves; depending on the physical position of the mobile handset on the user's body, the human body acts likes a low level shield blocking the quality of the signal when the handset is behind the user as they approach a reader; humidity affects signal strength characteristics; proximity to metal, marble, and other surfaces; accessories attached to the handset; and different antenna designs of different handset vendors provide constantly changing signal strength performance information by vendor and model and build dates. For these reasons, it is not practical to accurately predict that signal strength of each phone will directly correlate with a precise distance in all scenarios. The inclusion of directional antennas into the reader does not improve this situation. Instead, the directionality merely provides an indication of motion and the relative angle between the handset and the reader. With the inclusion of multiple readers with directional antennas, distance becomes possible with triangulation or more precisely trilateration. However, this requires high degrees of calibration and density of the readers. In practice, 30 feet of separation and distance calculations from a handset to a specific reader are inaccurate in consumer grade technology and in the antenna, in addition to size constraints of door or computer readers.

An objective of the present invention is to provide a convenient, touchless, and secure authentication experience at a door or computer for a person with a mobile handset in their pocket or on their person, regardless of handset vendor or brand. The present invention can be applied to door access for a person with a mobile phone containing a virtual credential wallet capable of communicating over Bluetooth Low Energy (BLE).

In one example, the user approaches the locked door from the front, starting at a distance of 150 feet and approaching the door sensor head on. As the user becomes closer to the door sensor, the different internal antennas begin to detect the presence of the person's phone with BLE radio. As the user gets closer, the sensors detect when the phone's signal strength has reached a configurable threshold for the sensor to authenticate with the wallet on the phone to determine if this is likely to be a person eligible for access. The sensor does not grant access yet and waits for proximity and direction conditions to be met. When the user is within a definable threshold—typically, 5 feet as determined by the optical sensor—the sensor confirms that the phone is indeed in front of, not behind, the sensor and that the wallet has not been spoofed by confirming the authentication information with the wallet. If these conditions are met, the sensor will inform the access system or the local door lock to grant access or provide a credential to the external system so it may determine if the credential should have access.

By combining both the omnidirectional antenna for vicinity presence, the directional antenna to ensure the mobile phone is directly in front of the sensor, and the optical sensor to confirm precise distance, the present invention solves the issue of omnidirectional signal strength as the only determining factor for proximity to the sensor, as used in competing systems. The availability of low cost optical sensors and miniature omnidirectional and unidirectional tuned radio antennas provides a unique opportunity to combine different sensory information and further combine it with logical models to both measure and predict the authentication intention of a person.

Another objective of the present invention is to understand the user's intent to open a door by understanding their direction, changes in their direction, their distance from the front of the sensor, their angle of arrival or departure from the front of the sensor, and their precise changes in their distance from the sensor. The present invention overcomes any reliance upon the antenna characteristics of the different manufacturers of handsets now and in the future. The present invention addresses spoofing of a valid, virtual credential from a user who has authenticated via the omnidirectional antenna. If that same virtual credential is not seen in near range on the unidirectional antenna, then the person in front of the sensor is not the user holding the mobile handset.

Another objective of the present invention is to provide a sensor device as part of a door reader replacement that can be installed on the same legacy wiring commonly found in door readers. The present invention can uniquely utilize legacy wiring for power and integrate WiFi for high speed data. This means that the installation of the present invention will not require replacing said legacy wiring with new wiring infrastructure to earn the benefits of the present invention.

### SUMMARY OF THE INVENTION

The present invention is a sensor device comprising an omnidirectional BLE radio antenna, a unidirectional BLE radio antenna, a forward-facing LiDAR, and output logic to instruct access or to control local access to a resource, e.g. a door lock. The preferred embodiment of the present invention further comprises an optical camera and a radar. In the preferred embodiment of the present invention, said sensor device can utilize commonly found legacy wiring for power combined with WiFi signaling for high speed data transfer.

The present invention teaches a method of combining different sensors and radio antennas to address the unpredictable state of transmission characteristics of a mobile handset's BLE radio to accurately determine a person's intention to authenticate to a door or computer merely by their physical action of approaching a door or computer.

### BRIEF DESCRIPTION OF THE DRAWINGS

FIG. 1 is a flowchart describing the present invention.

FIG. 2 is an illustration of the present invention.

FIG. 3 is an illustration of the present invention including a user behind the sensor device.

FIG. 4 is an illustration of the present invention including multiple users in front of the sensor device.

FIG. 5 is an illustration of the present invention including multiple users behind the sensor device.

FIG. 6 is an illustration of the present invention including the directionality of the user in front of the sensor device.

FIG. 7 is an illustration of the present invention including specific large motion gestures such as waving of a hand.

FIG. 8 is an illustration of the present invention including various connections with legacy access control systems.

FIG. 9 is an illustration of the present invention including the forward-facing LiDAR measuring the approximate head, shoulders, and height of an approaching person.

FIG. 10 is an illustration of the present invention including the forward-facing LiDAR discerning the facial features of an approaching person.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.” The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header. All illustrations of the drawings are for the purpose of describing selected versions of the present invention and are not intended to limit the scope of the present invention.

The present disclosure includes many aspects and features. Moreover, while many aspects and features relate to, and are described in the context of the disclosed use cases, embodiments of the present disclosure are not limited to use only in this context.

In the present disclosure, a “mobile handset” may be a mobile phone, an electronic badge, or other device capable of transmitting authenticating credential information used for authentication to buildings, resources, enterprise systems, and other secured points of access. Accordingly, a “mobile wallet” is a software wallet that exists on a mobile handset where the mobile wallet contains one or more virtual credentials or electronic badges.

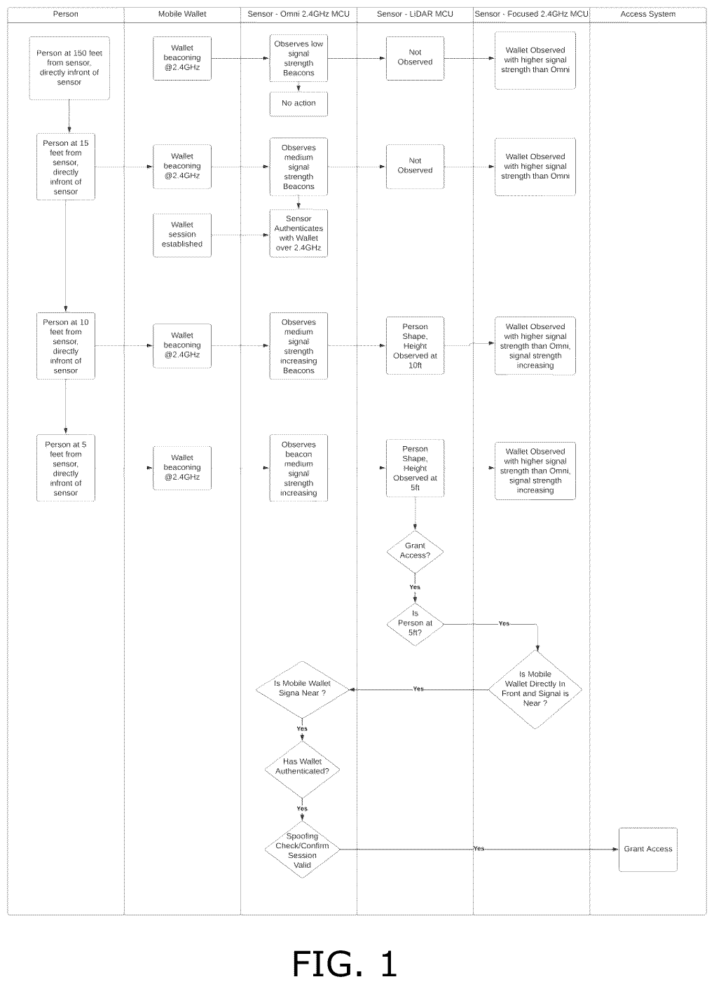

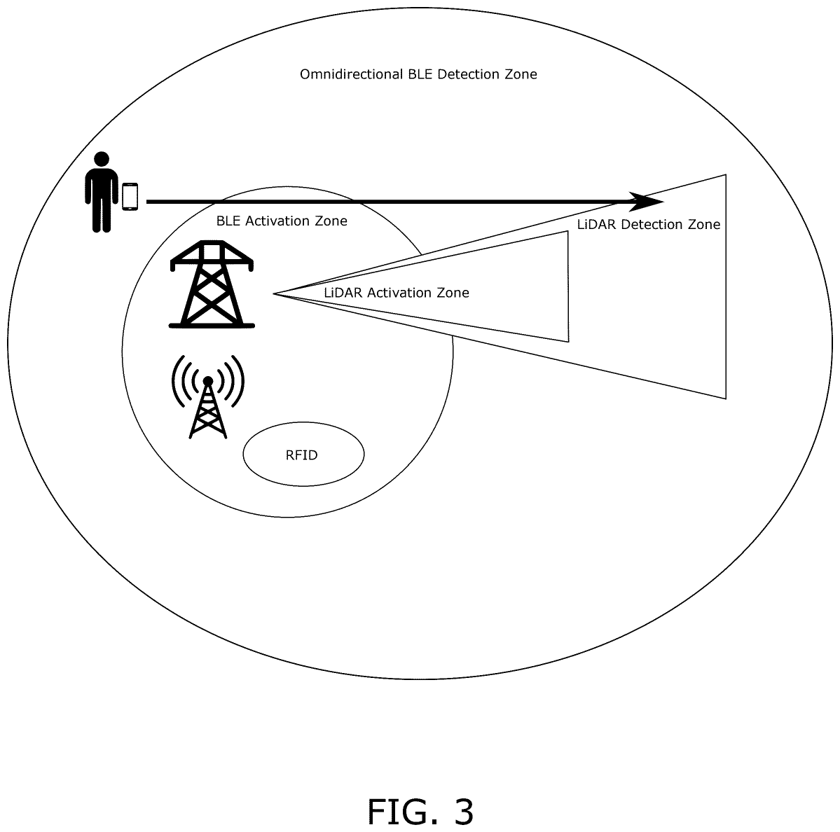

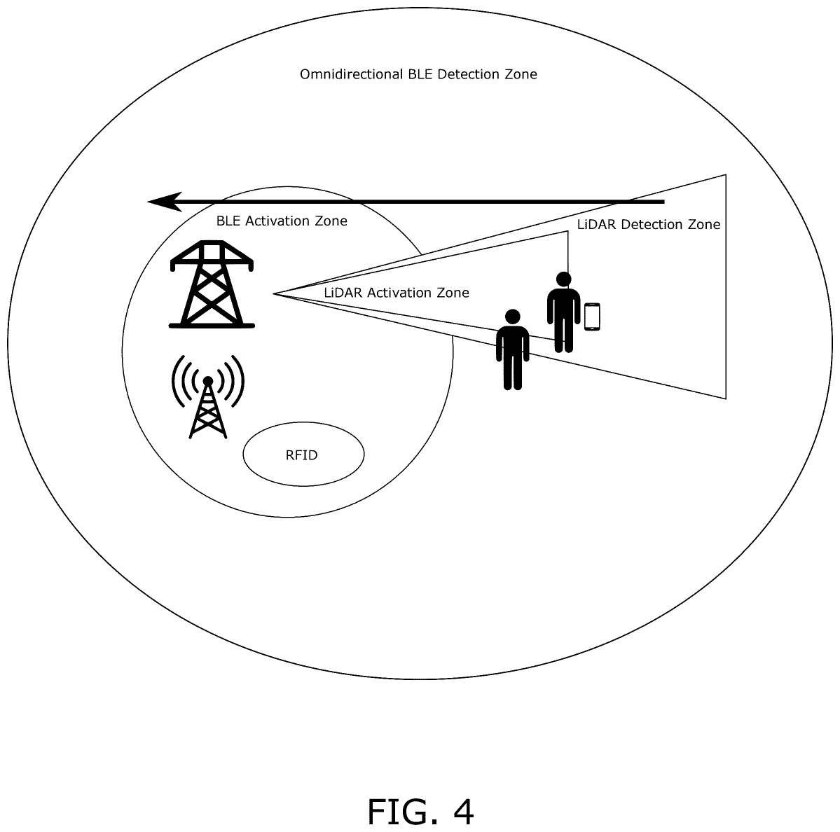

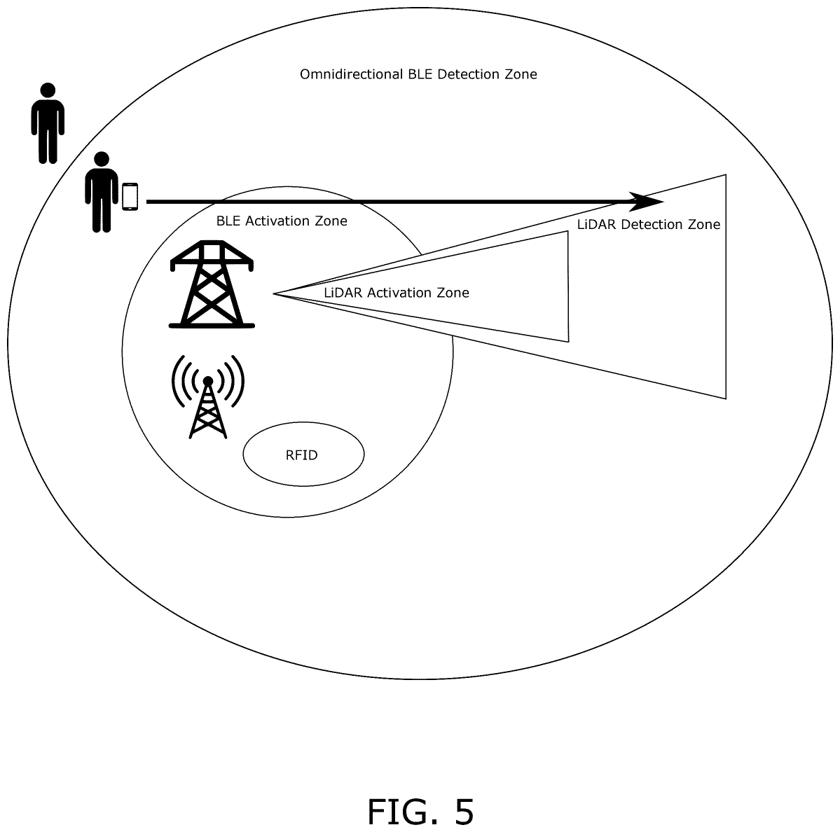

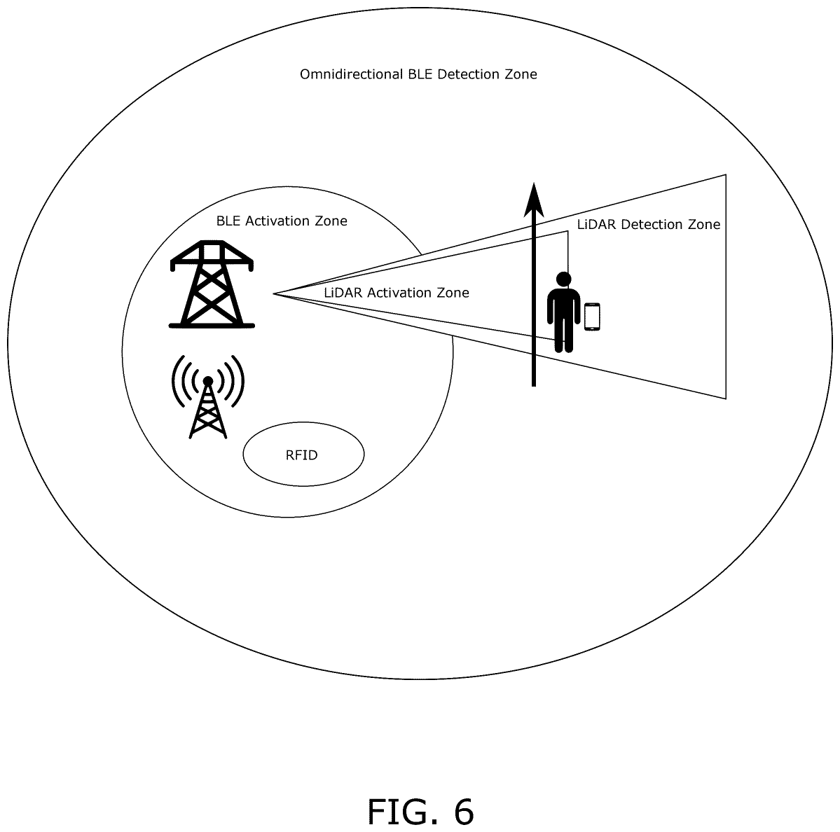

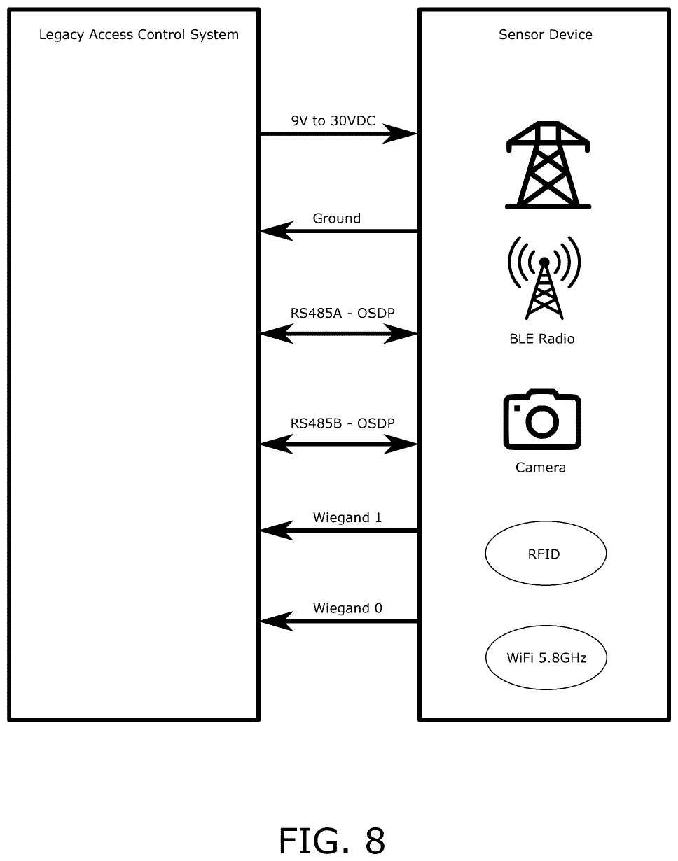

As described in FIG. 1-10, the present invention is a sensor device comprising an omnidirectional BLE radio antenna, a unidirectional BLE radio antenna, a forward-facing LiDAR, and output logic to instruct access or to control local access to a resource, e.g. a door lock. The preferred embodiment of the present invention further comprises an optical camera and radar.

Said omnidirectional BLE radio antenna detects the BLE radio transmissions created by the mobile handset wallet software, the mobile handset operating system, or other authenticating digital credential. An omnidirectional BLE radio antenna alone cannot determine the distance or direction of the mobile handset whether the mobile handset is in front, behind, above, or below the sensor device, or the directionality of the mobile handset e.g. left to right, or right to left. Instead, an omnidirectional BLE radio alone can only determine whether the mobile handset is within three states: close, near, or far.

Said unidirectional BLE radio antenna can determine if the mobile handset is in front of said sensor device. By combining said unidirectional BLE radio antenna with said omnidirectional BLE radio antenna, said sensor device can determine whether the mobile handset is close, near, or far and whether the mobile handset is in front of the sensor device or not.

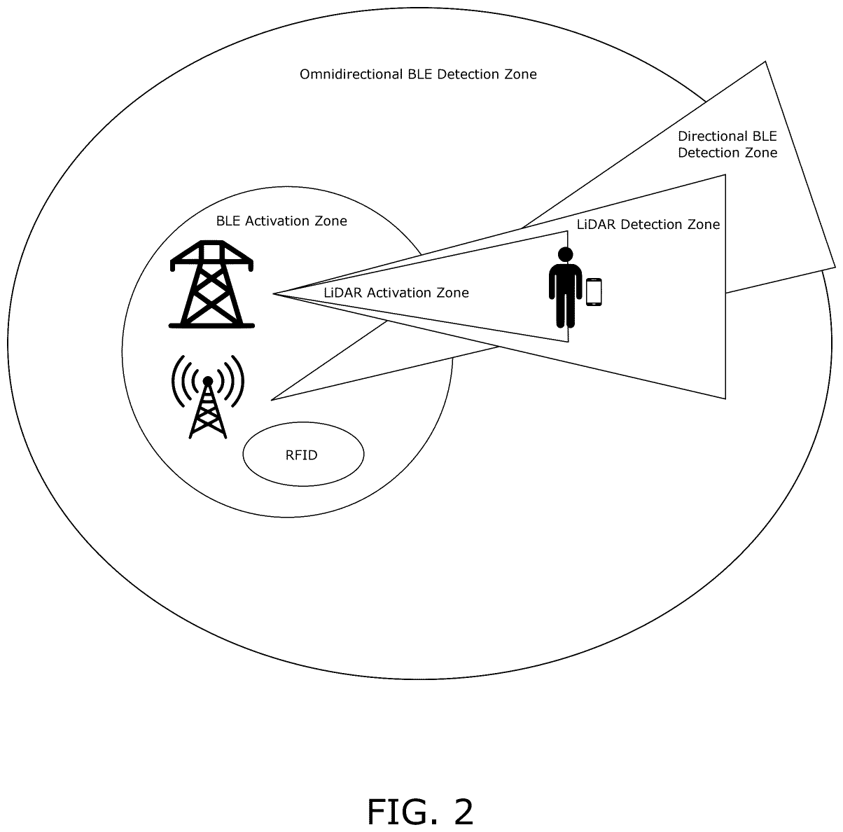

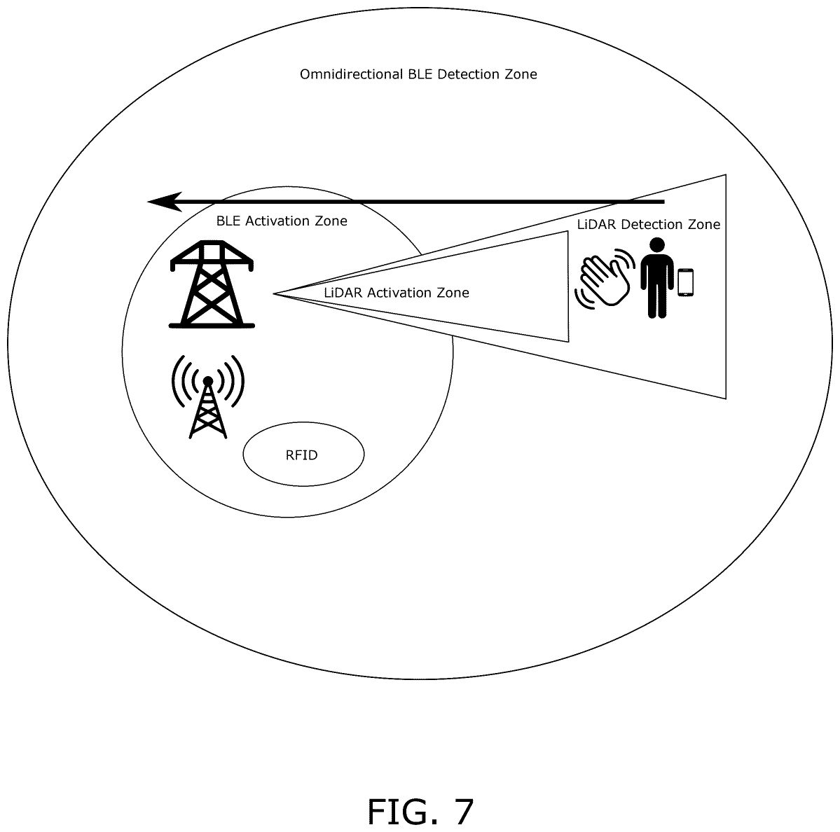

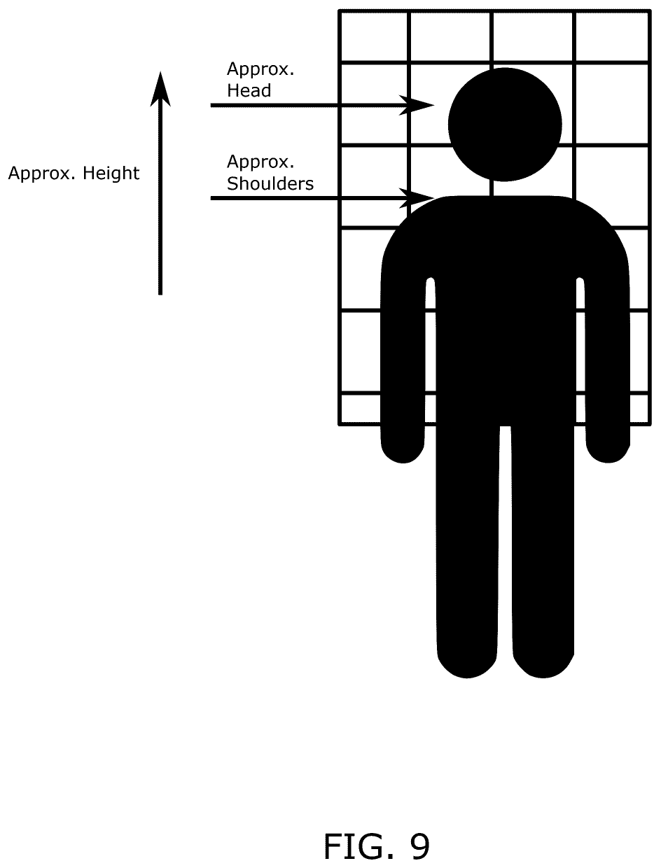

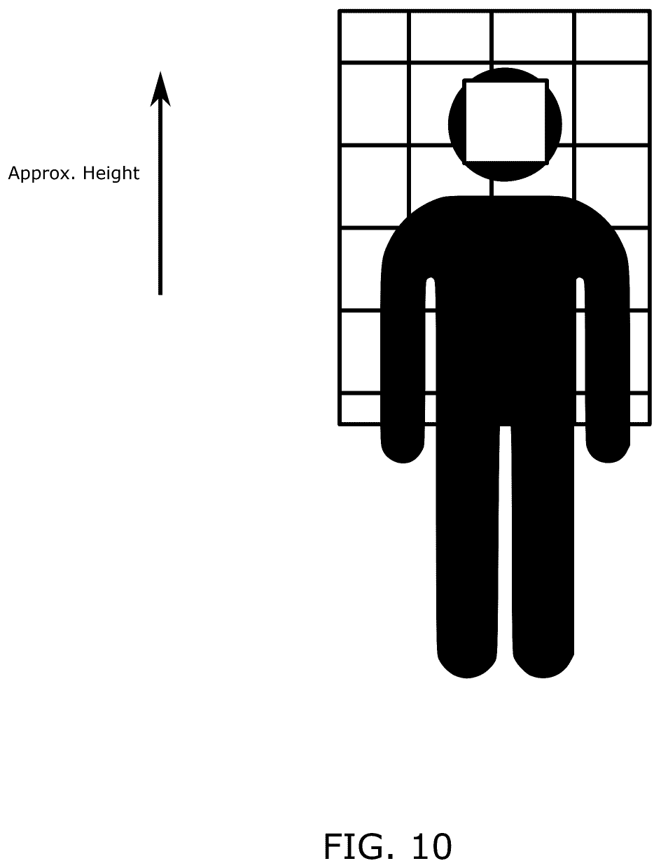

Said forward-facing LiDAR can accurately measure the number and the distance of fixed and moving objects in front of the sensor device. The sensor uses a LiDAR with 64 measure points across a 90 degree field of view. These 64 points are in effect the resolution of the LiDAR sensor. By combing the forward-facing LiDAR with the omnidirectional BLE radio antenna and the unidirectional BLE radio antenna shown in FIG. 2-7, the sensor device can determine: how far away an object is with millimeter accuracy up to 4 meters away; how many objects are in front of the sensor device; the directionality of those objects; the relative height and width of the object as a function of distance to the resolution of the LiDAR; specific large motion gestures such as holding a hand out, waving of a hand, etc., as particularly shown in FIG. 7; and depth of contours of specific objects limited to the resolution of the object within partial or total field of view. As particularly shown in FIGS. 9 and 10, said forward-facing LiDAR determines a rough 3D “fingerprint” of an approaching person. The mobile handset in possession of the person provides said sensor device with a LiDAR template of the mobile handset's owner. This template allows said sensor device to further discern and differentiate between holders of mobile handset credentials. By using a LiDAR template, said sensor device can differentiate between a person's height, size, and facial features. Said forward-facing LiDAR begins to process measurement data at approximately 8 ft away from said sensor device when a person is in full view of said sensor device and continues to track and measure as the person approaches. In addition to detection of objects and persons, said forward-facing LiDAR may be used to map 3D features to millimeter accuracy of a target, further enhancing the level of identification to full biometric authentication to the particular mobile handset. This level of precision allows for the discerning of the person with the correct corresponding mobile handset and provides a strong second factor of authentication and future reauthentication. Said forward-facing LiDAR has a resolution which allows for hundreds of measurements across a person's body to develop a contour of the person's features. Advantageously, storing of LiDAR templates within the mobile wallet or mobile handset eliminates the need for said sensor device to store or retain the LiDAR template locally.

Said output logic combines detections from said omnidirectional BLE radio antenna, said unidirectional BLE radio antenna, and said forward-facing LiDAR to determine if an authenticating mobile handset is near said sensor device, if an authenticating mobile handset is in front of said sensor device, and if an authenticating mobile handset is in possession of a user that intends to access beyond said sensor device. Said sensor device uses said omnidirectional BLE radio antenna and said unidirectional BLE radio antenna to determine if a nearby mobile handset is authenticating. Said forward-facing LiDAR further determines if the nearby authenticating mobile handset is in possession of a user that intends to access beyond said sensor device and not otherwise in possession of a user nearby that does not intend to access beyond said sensor device. The combination of these components controlled by said output logic allows said sensor device to prevent access to intruders who may be attempting to gain access beyond said sensor device through authentication of another user nearby.

The preferred embodiment of the present invention further comprises an optical camera. Said optical camera may be triggered at the correct distance to capture an image of the person as they approach and depart from a doorway. The combination of the LiDAR and said optical camera enables the sensor device to limit its recording of images to only potentially useful frames where the person may be fully seen. This combination further creates an opportunity for biometric confirmation. In the preferred embodiment of the present invention, said optical camera operates using legacy wiring for power and WiFi for high speed data transfer.

The preferred embodiment of the present invention further comprises a radar. Across different lighting conditions, LiDAR exhibits limited effective range. Under ideal conditions, LiDAR provides reliable detection between 5-8 ft. Under direct sunlight and under store lighting, the effective range of LiDAR detection is between 1-4 ft. Other factors of obfuscation, including rainfall and condensation, further affects the effective range of accurate, reliable detection. To compensate for the weaknesses of LiDAR, implementing radar provides reliable detection at longer ranges. In contrast to LiDAR, radar can suffer from poor accuracy and performance at short distances within a few feet of a sensor. Therefore, a combination of LiDAR, radar, and the BLE radio antenna array provides the optimal end user experience. Radar accurately determines people between 4-30 ft and can determine the number of people within that range. LiDAR confirms the intention of the person to enter through a door under 4 feet. Finally, the BLE radio antenna array can confirm if the target phone or device is indeed within the desired frontal location of the sensor.

Although the invention has been explained in relation to its preferred embodiment, it is to be understood that many other possible modifications and variations can be made without departing from the spirit and scope of the invention.

What is claimed is:

1. A sensor device comprising:
an omnidirectional BLE radio antenna;
a unidirectional BLE radio antenna;
a forward-facing LiDAR;
output logic to instruct access or to control local access to a resource;
wherein said omnidirectional BLE radio antenna can detect the distance of a mobile handset or other authenticating digital credential;
wherein said unidirectional BLE radio antenna can detect whether a mobile handset or other authenticating digital credential is in front of said sensor device;
wherein said forward-facing LiDAR can detect the number and distance of fixed and moving objects in front of said sensor device; and
wherein said output logic combines detection data from said omnidirectional BLE radio antenna, said unidirectional BLE radio antenna, and said forward-facing LiDAR to authenticate a mobile handset or other authenticating digital credential.

2. The device of claim 1, further comprising:
an optical camera.

3. The device of claim 1, further comprising:
a radar.

4. The device of claim 1:
wherein said forward-facing LiDAR can detect the intent to authenticate a mobile handset or other authenticating digital credential.

5. The device of claim 4:
wherein physical gestures or motions can be used to indicate intent to authenticate a mobile handset or other authenticating digital credential.

6. The device of claim 1:
wherein said forward-facing LiDAR does not automatically authentication a mobile handset or other authenticating digital credential if more than one mobile handset or other authenticating digital credential is detected.

7. The device of claim 1:
wherein said forward-facing LiDAR verifies LiDAR templates of users before authenticating a mobile handset or other authenticating digital credential.

8. The device of claim 1:
wherein said sensor device obtains power from a legacy 12V or 24V access control wiring system.

9. A sensor device comprising:
an omnidirectional BLE radio antenna;
a unidirectional BLE radio antenna;
a forward-facing LiDAR;
output logic to instruct access or to control local access to a resource;
wherein said omnidirectional BLE radio antenna can detect the distance of a mobile handset or other authenticating digital credential;
wherein said unidirectional BLE radio antenna can detect whether a mobile handset or other authenticating digital credential is in front of said sensor device;
wherein said forward-facing LiDAR can detect the number and distance of fixed and moving objects in front of said sensor device;
wherein said forward-facing LiDAR can detect the intent to authenticate a mobile handset or other authenticating digital credential;
wherein physical gestures or motions can be used to indicate intent to authenticate a mobile handset or other authenticating digital credential; and
wherein said output logic combines detection data from said omnidirectional BLE radio antenna, said unidirectional BLE radio antenna, and said forward-facing LiDAR to authenticate a mobile handset or other authenticating digital credential.

10. The device of claim 9, further comprising:
an optical camera.

11. The device of claim 9, further comprising:
a radar.

12. The device of claim 9:
wherein said forward-facing LiDAR does not automatically authentication a mobile handset or other authenticating digital credential if more than one mobile handset or other authenticating digital credential is detected.

13. The device of claim 9:
wherein said forward-facing LiDAR verifies LiDAR templates of users before authenticating a mobile handset or other authenticating digital credential.

14. The device of claim 9:
wherein said sensor device obtains power from a legacy 12V or 24V access control wiring system.

15. A sensor device comprising:
an omnidirectional BLE radio antenna;
a unidirectional BLE radio antenna;
a forward-facing LiDAR;
output logic to instruct access or to control local access to a resource;
wherein said omnidirectional BLE radio antenna can detect the distance of a mobile handset or other authenticating digital credential;
wherein said unidirectional BLE radio antenna can detect whether a mobile handset or other authenticating digital credential is in front of said sensor device;
wherein said forward-facing LiDAR can detect the number and distance of fixed and moving objects in front of said sensor device;
wherein said forward-facing LiDAR can detect the intent to authenticate a mobile handset or other authenticating digital credential;
wherein physical gestures or motions can be used to indicate intent to authenticate a mobile handset or other authenticating digital credential;
wherein said output logic combines detection data from said omnidirectional BLE radio antenna, said unidirectional BLE radio antenna, and said forward-facing LiDAR to authenticate a mobile handset or other authenticating digital credential; and
wherein said sensor device obtains power from a legacy 12V or 24V access control wiring system.

16. The device of claim 15, further comprising:
an optical camera.

17. The device of claim 15, further comprising:
a radar.

18. The device of claim 15:
wherein said forward-facing LiDAR does not automatically authentication a mobile handset or other authenticating digital credential if more than one mobile handset or other authenticating digital credential is detected.

19. The device of claim 15:
wherein said forward-facing LiDAR verifies LiDAR templates of users before authenticating a mobile handset or other authenticating digital credential.
